(19) United States
(12) Patent Application Publication
(10) Pub. No.: US 2022/0258631 A1
(43) Pub. Date: Aug. 18, 2022

(54) CHARGING APPARATUS

(71) Applicant: TOYOTA JIDOSHA KABUSHIKI KAISHA, Aichi-ken (JP)

(72) Inventors: Yoshiyuki TSUCHIYA, Nagoya-shi (JP); Kazuki KUBO, Toyota-shi (JP)

(21) Appl. No.: 17/555,508

(22) Filed: Dec. 20, 2021

(30) Foreign Application Priority Data
Feb. 17, 2021 (JP) 2021-023095

(51) Int. Cl. B60L 53/31; B60L 53/16; B60L 53/30; G07C 9/23

(52) U.S. Cl. CPC B60L 53/31; B60L 53/16; B60L 53/66; G07C 9/23; B60L 53/305

(57) ABSTRACT

A charging apparatus installed at a bottom of a hollow in a ground and configured to charge a power storage device mounted on a vehicle includes a movable unit, an ascending and descending device, a communication device, and a control device. The ascending and descending device is configured to cause the movable unit to ascend or descend between a first state and a second state. The communication device is configured to communicate with a device outside the charging apparatus. The control device is configured to permit ascent of the movable unit when the following conditions are satisfied: (i) the charging apparatus is in the first state; (ii) request information indicating a request to charge a charging target vehicle is received via the communication device; and (iii) determination is made that an authentication process for permitting charging of the charging target vehicle is completed.

### CROSS-REFERENCE TO RELATED APPLICATION

This application claims priority to Japanese Patent Application No. 2021-023095 filed on Feb. 17, 2021, incorporated herein by reference in its entirety.

### BACKGROUND

### 1. Technical Field

The present disclosure relates to a charging apparatus configured to charge an on-board power storage device.

### 2. Description of Related Art

Charging apparatuses for charging power storage devices mounted on vehicles or the like are installed at parking lots or sidewalks outside the vehicles or the like. However, the charging apparatuses may hinder pedestrians from walking or vehicles from traveling because the charging apparatuses occupy installation spaces. Therefore, there is known a technology in which the charging apparatus is movable and housed, for example, under the ground.

For example, Japanese Unexamined Patent Application Publication No. 2011-109807 (JP 2011-109807 A) discloses a charging pole ascendable or descendable to stand on the ground or to be housed under the ground.

### SUMMARY

To use the movable charging apparatus ascendable and descendable as described above, authentication may be required to permit only a specific user (for example, a user who has paid a usage fee) to use the charging apparatus. For example, the user authentication is required when using the charging apparatus. To operate the charging apparatus or connect the charging apparatus to a vehicle or the like, the charging apparatus to be used is required to stand on the ground. The user needs to wait with the availability remaining unclear until the charging apparatus comes to stand on the ground. Therefore, the convenience of the charging apparatus may be spoiled.

The present disclosure provides a charging apparatus in which authentication for charging can be executed without spoiling convenience.

A charging apparatus according to an aspect of the present disclosure is installed at a bottom of a hollow in a ground and configured to charge a power storage device mounted on a vehicle. The charging apparatus includes a movable unit, an ascending and descending device, a communication device, and a control device. The movable unit includes a connection device configured to connect to the power storage device. The ascending and descending device is configured to cause the movable unit to ascend or descend between a first state and a second state. The first state is a state in which the movable unit is housed under the ground. The second state is a state in which the movable unit is exposed above the ground and the power storage device and the connection device are connectable together. The communication device is configured to communicate with a device outside the charging apparatus. The control device is configured to control the ascending and descending device by using information received via the communication device. The control device is configured to permit ascent of the movable unit when following conditions (i) to (iii) are satisfied: (i) the charging apparatus is in the first state; (ii) request information indicating a request to charge a charging target vehicle is received via the communication device; and (iii) determination is made that an authentication process for permitting charging of the charging target vehicle is completed.

In the charging apparatus according to the aspect of the present disclosure, the authentication process can be executed while keeping the first state of the charging apparatus. Therefore, whether the charging apparatus is available to a user can be determined without setting the charging apparatus into the second state. Thus, the spoilage of the convenience of the charging apparatus can be suppressed.

In the charging apparatus according to the aspect of the present disclosure, the control device may be configured to execute the authentication process when the request information is received.

In the charging apparatus according to the aspect of the present disclosure, whether the charging apparatus is available to the user can be determined without setting the charging apparatus into the second state. Thus, the spoilage of the convenience of the charging apparatus can be suppressed.

In the charging apparatus according to the aspect of the present disclosure, the device outside the charging apparatus may include a server and a device configured to transmit the request information. The authentication process may be executed by the server.

In the charging apparatus according to the aspect of the present disclosure, whether the charging apparatus is available to the user can be determined without setting the charging apparatus into the second state. Thus, the spoilage of the convenience of the charging apparatus can be suppressed.

In the charging apparatus according to the aspect of the present disclosure, the device configured to transmit the request information may include at least one of a mobile terminal and the vehicle. The control device may be configured to, when the request information is received, acquire information necessary for the authentication process from the device configured to transmit the request information.

In the charging apparatus according to the aspect of the present disclosure, the authentication process can be executed by using the information acquired from the device configured to transmit the request information. Thus, the authentication process can be executed while keeping the first state of the charging apparatus.

According to the aspect of the present disclosure, it is possible to provide the charging apparatus in which the authentication for charging can be executed without spoiling the convenience.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating an example of the structures of a motor vehicle and a charging stand whose movable unit is housed under the ground;

FIG. 2 is a diagram illustrating an example of the structures of the motor vehicle and the charging stand whose movable unit is exposed above the ground;

FIG. 3 is a diagram illustrating an example of a layout of charging stands and parking spaces;

FIG. 4 is a diagram illustrating another example of the layout of the charging stands and the parking spaces;

FIG. 5 is a flowchart illustrating an example of processes to be executed by a control device of the charging stand;

FIG. 6 is a flowchart illustrating an example of processes to be executed by the control device of the charging stand according to a modified example; and

FIG. 7 is a diagram illustrating an example of the structures of a motor vehicle and a charging stand according to a modified example.

### DETAILED DESCRIPTION OF EMBODIMENTS

An embodiment of the present disclosure is described below in detail with reference to the drawings. In the drawings, the same or corresponding parts are represented by the same reference symbols to omit redundant description.

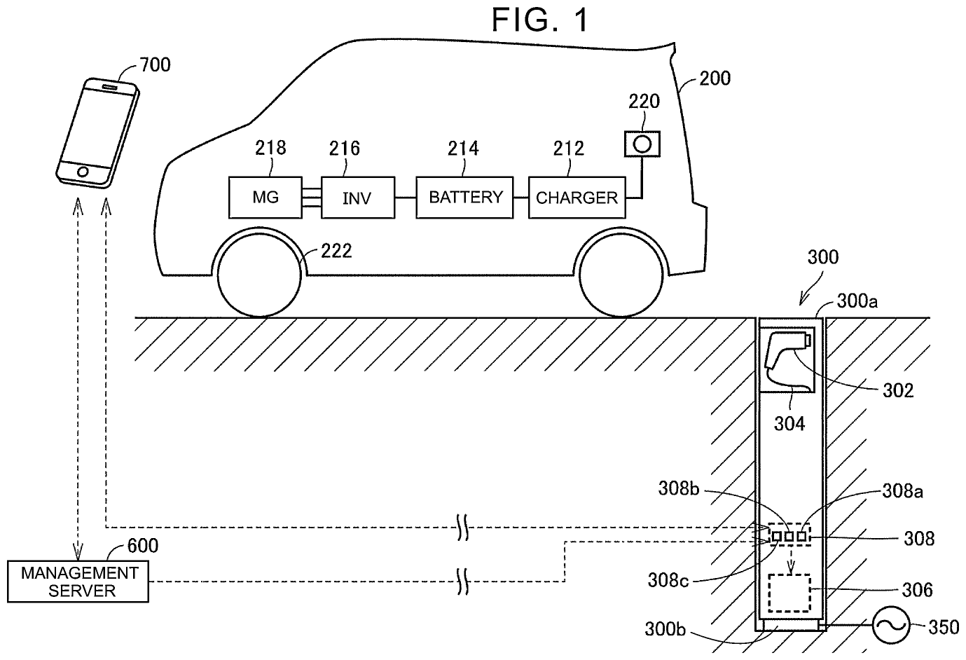

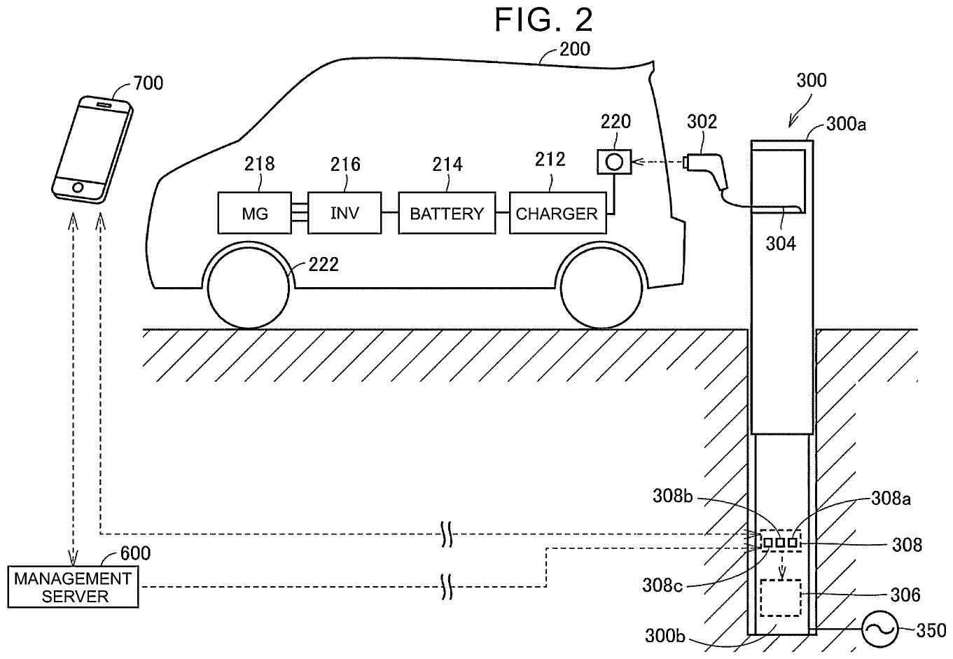

For example, description is given of the structure of a charging stand 300 serving as a charging apparatus according to the embodiment of the present disclosure. FIG. 1 is a diagram illustrating an example of the structures of a motor vehicle 200 and the charging stand 300 whose movable unit 300a (described later) is housed under the ground. FIG. 2 is a diagram illustrating an example of the structures of the motor vehicle 200 and the charging stand 300 whose movable unit 300a is exposed above the ground.

As illustrated in FIG. 1 and FIG. 2, the charging stand 300 is ascendable and descendable between a first state (see FIG. 1) in which the upper end is positioned substantially flush with the ground and the movable unit 300a is housed under the ground, and a second state (see FIG. 2) in which the upper end ascends to a predetermined position above the ground and the movable unit 300a is exposed.

For example, the charging stand 300 includes a cylindrical casing, and is installed at the bottom of a hollow in the ground. The hollow in the ground has a predetermined clearance from the outer peripheral surface of the casing of the charging stand 300, and the depth of the hollow is approximately equal to the vertical length of the charging stand 300 in the first state.

The charging stand 300 includes the movable unit 300a and a stationary unit 300b. A housing space that can house a connector 302 is formed at the top of the movable unit 300a. The connector 302 is connected to one end of a cable 304 whose other end is connected to a power supply 350. The power supply 350 is an alternating current (AC) power supply such as a commercial power supply. For example, the cable 304 includes a formative extensible and contractible portion including a curl portion, or a structural extensible and contractible portion including a take-up structure. When the connector 302 is carried, the cable 304 is extensible to an inlet 220 of the motor vehicle 200 parked in a parking space.

The stationary unit 300b is fixed to the bottom of the hollow in the ground. The stationary unit 300b may be fixed anywhere in the hollow in the ground, and need not particularly be fixed to the bottom of the hollow.

The stationary unit 300b includes an ascending and descending device 306 configured to cause the movable unit 300a to ascend or descend in a vertical direction, and a control device 308 configured to control operations of the ascending and descending device 306.

The ascending and descending device 306 includes an actuator configured to cause the movable unit 300a to ascend or descend. For example, the ascending and descending device 306 may include a rack and pinion mechanism configured to cause the movable unit 300a to ascend or descend by rotating, with an electric actuator, a pinion gear meshing with a rack gear fixed to the movable unit 300a, a mechanism using a hydraulic cylinder in which a rod connected to a piston is fixed to the movable unit 300a, and configured to cause the movable unit 300a to ascend or descend by increasing or reducing a hydraulic pressure to be supplied to a cylinder body fixed to the stationary unit 300b, or a mechanism configured to cause the movable unit 300a to ascend or descend by generating a repulsive force with a magnetic force between the movable unit 300a and the stationary unit 300b.

The ascending and descending device 306 is configured such that the movable unit 300a does not descend below a position corresponding to the first state and does not ascend above a position corresponding to the second state by using, for example, stopper mechanisms.

The control device 308 includes a central processing unit (CPU) 308a, a memory 308b including a read only memory (ROM) and a random access memory (RAM), and a communicator 308c communicable with external devices. The control device 308 controls electric devices (for example, the ascending and descending device 306) provided in the charging stand 300 based on information stored in the memory 308b, information received via the communicator 308c, or information acquired from sensors (not illustrated). The electric devices may be controlled not only by a structure in which the CPU 308a executes software processes, but also by a structure constituted by dedicated hardware (electronic circuit). The communicator 308c is an example of a communication device communicable with a device outside the charging apparatus.

The communicator 308c can communicate various types of information with devices outside the charging stand 300. FIG. 1 and FIG. 2 illustrate an example in which the communicator 308c is communicable with a mobile terminal 700 and also with a management server 600.

For example, the communicator 308c may communicate with the management server 600 through wired communication. For example, the communicator 308c may communicate with the mobile terminal 700 or the management server 600 through wireless communication.

For example, when an execution condition for ascending control is satisfied, the control device 308 executes the ascending control on the ascending and descending device 306 to switch the charging stand 300 from the first state to the second state. For example, the execution condition for the ascending control includes a condition that the charging stand 300 is in the first state, and a condition that a request to execute the ascending control (hereinafter referred to as “ascending request”) is made for the charging stand 300. For example, the control device 308 may receive information indicating the ascending request from the mobile terminal 700, or determine whether the ascending request is made based on information from an external device.

For example, when an execution condition for descending control is satisfied, the control device 308 executes the descending control on the ascending and descending device 306 to switch the charging stand 300 from the second state to the first state. For example, the execution condition for the descending control includes a condition that the charging stand 300 is in the second state, and a condition that a request to execute the descending control (hereinafter referred to as “descending request”) is made for the charging stand 300. For example, the control device 308 may receive information indicating the descending request from the mobile terminal 700, or determine whether the descending request is made based on information from an external device.

The management server 600 includes a control device, a communication device, and a storage device (none of which is illustrated). The communication device of the management server 600 is communicable with the charging stand 300 or the mobile terminal 700 directly or via a communication network. The storage device of the management server 600 stores predetermined information. The control device of the management server 600 receives predetermined information from the mobile terminal 700 or the charging stand 300 via the communication device, or stores a part or all of the received information in the storage device.

The mobile terminal 700 can be carried by a user. For example, the mobile terminal 700 includes a display device, an input device, and a communication device (none of which is illustrated). The communication device of the mobile terminal 700 is communicable with the management server 600 via a communication network (not illustrated). The communication device of the mobile terminal 700 is communicable with the charging stand 300 directly or via the communication network.

FIG. 1 and FIG. 2 further illustrate an example of the structure of the motor vehicle 200 parked in a parking space where charging is available at the charging stand 300. As illustrated in FIG. 1 and FIG. 2, the motor vehicle 200 is a vehicle including a power storage device, such as a plug-in hybrid vehicle or an electric vehicle. The motor vehicle 200 only needs to receive electric power supplied from the charging stand 300, and is not particularly limited to the vehicles exemplified above. For example, the motor vehicle 200 may be a vehicle including a power storage device for external power feed.

The motor vehicle 200 includes a charger 212, a battery 214, an inverter 216, a motor generator 218, and the inlet 220.

When AC power is supplied from the inlet 220, the charger 212 converts the supplied AC power into direct current (DC) power, and supplies the DC power to the battery 214. The battery 214 is charged through the operation of the charger 212. For example, the charger 212 is controlled based on a control signal from an electronic control unit (ECU) (not illustrated).

For example, the battery 214 is a rechargeable power storage element typified by a secondary battery such as a nickel-metal hydride battery or a lithium ion battery including a liquid or solid electrolyte. Alternatively, the battery 214 may be a power storage device that can store electric power. For example, a large-capacity capacitor may be used in place of the battery 214.

For example, the inverter 216 converts DC power of the battery 214 into AC power, and supplies the AC power to the motor generator 218. For example, the inverter 216 converts AC power from the motor generator 218 (regenerative power) into DC power, and supplies the DC power to the battery 214 to charge the battery 214.

The motor generator 218 gives a rotational force to driving wheels 222 by receiving electric power supplied from the inverter 216. The driving wheels 222 are rotated by the rotational force given from the motor generator 218 to cause the motor vehicle 200 to travel.

The inlet 220 is provided together with a cover (not illustrated) such as a lid at a part of the exterior of the motor vehicle 200. The inlet 220 is a power receiver configured to receive charging power supplied from an external charging apparatus (for example, the charging stand 300). The inlet 220 is shaped such that the connector 302 of the charging stand 300 is attachable to the inlet 220. Both the inlet 220 and the connector 302 include contacts. When the connector 302 is attached to the inlet 220, the contacts are brought into contact with each other, and the inlet 220 and the connector 302 are electrically connected together. At this time, the battery 214 of the motor vehicle 200 is chargeable with electric power supplied from the charging stand 300.

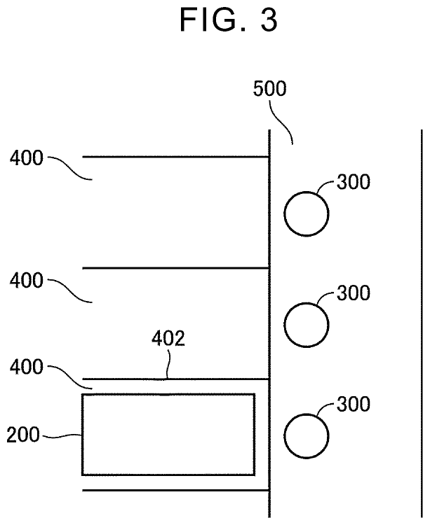

The charging stands 300 may be installed on a sidewalk adjacent to a plurality of parking spaces in a parking lot, or on a sidewalk adjacent to a plurality of parking spaces set along a road. FIG. 3 is a diagram illustrating an example of a layout of the charging stands 300 and parking spaces 400. As illustrated in FIG. 3, when the parking spaces 400 are set side by side across partition lines 402 at a plurality of positions in a parking lot, the charging stands 300 are installed at positions adjacent to the respective parking spaces 400. For example, FIG. 3 illustrates a structure in which a sidewalk 500 is provided at one longitudinal end of each parking space 400 (right side on the drawing sheet of FIG. 3). In this case, the charging stands 300 are installed along the sidewalk 500. When the motor vehicle 200 is parked in any one of the parking spaces 400 and the charging stand 300 is in the second state, the user carries the connector 302 from the charging stand 300 and connects the connector 302 to the inlet 220 of the motor vehicle 200.

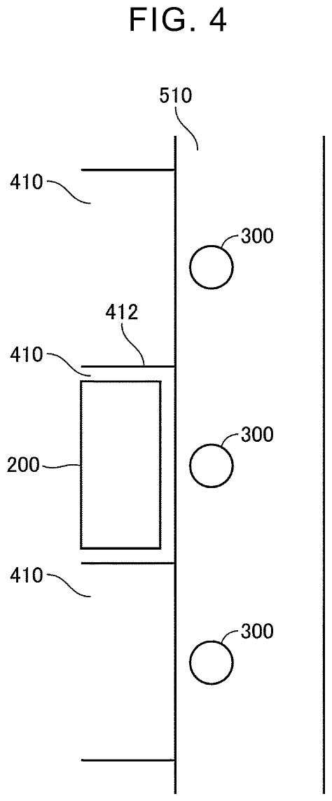

FIG. 4 is a diagram illustrating another example of the layout of the charging stands 300 and parking spaces 410. As illustrated in FIG. 4, when the parking spaces 410 are set end to end across partition lines 412 at a plurality of positions along a road, the charging stands 300 are installed at positions adjacent to the respective parking spaces 410. For example, FIG. 4 illustrates a structure in which the parking spaces 410 are set along a sidewalk 510. In this case, the charging stands 300 are installed along the sidewalk 510. When the motor vehicle 200 is parked in any one of the parking spaces 410 and the charging stand 300 is in the second state, the user carries the connector 302 from the nearest charging stand 300 and connects the connector 302 to the inlet 220 of the motor vehicle 200.

Authentication may be required to permit only a specific user (for example, a user who has paid a usage fee) to use the movable charging stand 300 ascendable and descendable as described above. For example, the user authentication is required when using the charging stand 300. To operate the charging stand 300 or connect the charging stand 300 to the motor vehicle 200, the charging stand 300 to be used is required to be in the second state in which the charging stand 300 stands on the ground. The user needs to wait with the availability remaining unclear until the charging stand 300 comes to stand on the ground. Therefore, the convenience of the charging stand 300 may be spoiled. For example, as illustrated in FIG. 3 or FIG. 4, when the user is required to set any charging stand 300 into the second state for authentication to access the charging stand 300 to be used among the charging stands 300 installed at the plurality of positions but the selected charging stand 300 is wrong, the user needs to wait to set each charging stand 300 into the second state until the correct charging stand 300 is selected.

In this embodiment, when the charging stand 300 is in the first state and request information indicating a request to charge a charging target vehicle is received via the communicator 308c, the control device 308 of the charging stand 300 executes an authentication process for permitting the charging of the charging target vehicle. When the control device 308 determines that the authentication process is completed, the control device 308 executes the ascending control for causing the movable unit 300a to ascend.

Through the operations described above, the authentication process can be executed while keeping the first state of the charging stand 300. Therefore, whether the charging stand 300 is available to the user can be determined without setting the charging stand into the second state. Thus, the spoilage of the convenience of the charging stand 300 can be suppressed.

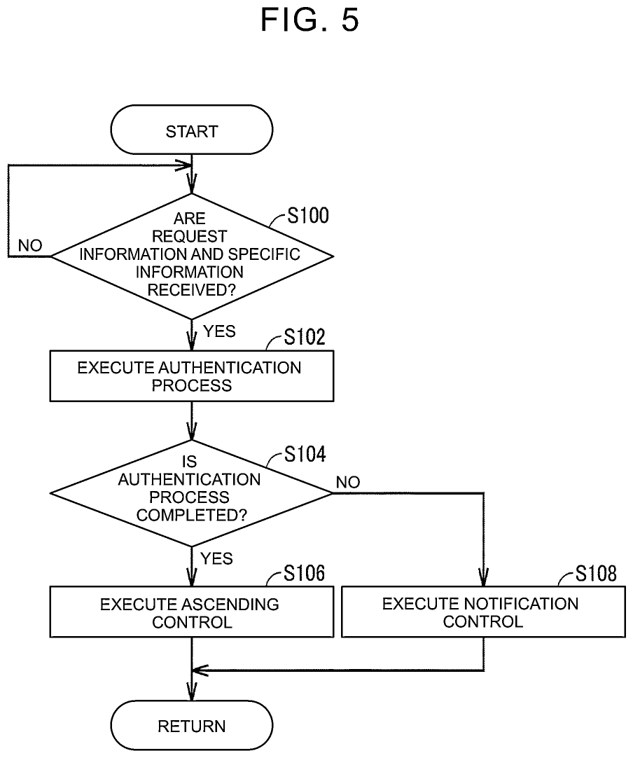

An example of control processes to be executed by the control device 308 is described below with reference to FIG. 5. FIG. 5 is a flowchart illustrating an example of the processes to be executed by the control device 308 of the charging stand 300. The series of processes illustrated in this flowchart is repeated in every predetermined control period.

In Step (hereinafter represented by “S”) 100, the control device 308 determines whether request information and specific information are received from the mobile terminal 700. The specific information is used to determine a user as a registered user who can use the charging stand 300.

For example, when the mobile terminal 700 comes into a range in which communication can be established with the charging stand 300 in a case where the user requests the charging stand 300 for charging by using the mobile terminal 700, the user establishes the communication between the mobile terminal 700 and the charging stand 300 by activating a dedicated application and performing an operation for establishing the communication, or the mobile terminal 700 automatically establishes the communication with the charging stand 300. When the communication is established with the charging stand 300, the mobile terminal 700 transmits the request information and the specific information to the charging stand 300.

For example, the specific information may be identification information related to the motor vehicle 200, the mobile terminal 700, or the user. The specific information may be identification information unique to the user, such as a phone number or an identification (ID) number assigned to the user when the user is preregistered as a user of the charging stand 300, identification information set by the user, such as a password registered at the time of preregistration, unique identification information such as a serial number of the motor vehicle 200 or the mobile terminal 700 that is registered at the time of preregistration, or information obtained by combining a plurality of pieces of the information described above. For example, those pieces of information are stored in the management server 600 at the time of preregistration.

The control device 308 determines that the request information and the specific information are received, for example, when the request information and the specific information are received before a predetermined period elapses. When determination is made that the request information and the specific information are received (“YES” in S100), the processes proceed to S102. When determination is made that the request information and the specific information are not received (“NO” in S100), the processes return to S100.

In S102, the control device 308 executes the authentication process. For example, the control device 308 determines whether the specific information received from the mobile terminal 700 includes information that agrees with information stored in the memory 308b. When determination is made that the specific information includes the information that agrees with the stored information, the authentication process is completed. When the authentication process is completed, the control device 308 sets an authentication flag to ON. For example, the information stored in the memory 308b includes the specific information transmitted from the management server 600 to the charging stand 300 at the time of preregistration.

In S104, the control device 308 determines whether the authentication process is completed. The control device 308 determines that the authentication process is completed, for example, when the authentication flag is ON. The control device 308 determines that the authentication process is not completed, for example, when the authentication flag is OFF. When determination is made that the authentication process is completed (“YES” in S104), the processes proceed to S106.

In S106, the control device 308 executes the ascending control. The control device 308 controls the ascending and descending device 306 to cause the movable unit 300a to ascend to the position corresponding to the second state. When determination is made that the authentication process is not completed (“NO” in S104), the processes proceed to S108.

In S108, the control device 308 executes notification control. That is, the control device 308 transmits, to the mobile terminal 700, information indicating that the authentication process is not completed (that is, the received specific information does not include the information that agrees with the information stored in the memory 308b). Then, the control device 308 terminates the processes.

Description is given of an example of operations of the control device 308 of the charging stand 300 serving as the charging apparatus according to this embodiment based on the structure and flowchart described above. For example, it is assumed that the user is registered as a registered user, and specific information of the user is stored in the storage device of the management server 600 and the memory 308b of the charging stand 300. It is also assumed that the user registered as the registered user parks the motor vehicle 200 in the parking space 400 (see FIG. 3) and then requests the charging stand 300 for charging by using the mobile terminal 700.

When the user activates a dedicated application usable in the mobile terminal 700 and operates a screen of the mobile terminal 700 during the activation to request a communicable charging stand 300 for charging, request information and specific information are transmitted from the mobile terminal 700 to the control device 308.

When the control device 308 receives the request information and the specific information from the mobile terminal 700 (“YES” in S100), the authentication process is executed by using the received specific information (S102).

By executing the authentication process, determination is made as to whether the received specific information includes information that agrees with information stored in the memory 308b. When the received specific information includes the information that agrees with the information stored in the memory 308b, the authentication process is completed, and the authentication flag is set to ON. When determination is made that the authentication process is completed (“YES” in S104), the ascending control is executed (S106). Therefore, the charging stand 300 is switched from the first state to the second state. As a result, the movable unit 300a is exposed. The user can charge the battery 214 mounted on the motor vehicle 200 by carrying the connector 302 housed in the movable unit 300a and connecting the connector 302 to the inlet 220.

When determination is made that the received specific information does not include the information that agrees with the information stored in the memory 308b, the authentication process is not completed (“NO” in S104), and the notification control is executed (S108). Therefore, information indicating that the authentication process is not completed is transmitted to the mobile terminal 700.

In the charging stand 300 serving as the charging apparatus according to this embodiment described above, the authentication process can be executed while keeping the first state of the charging stand 300. Therefore, whether the charging stand is available to the user can be determined without setting the charging stand into the second state. Thus, the spoilage of the convenience of the charging stand can be suppressed. Accordingly, it is possible to provide the charging apparatus in which the authentication for charging can be executed without spoiling the convenience.

Modified examples are described below. In the embodiment described above, the power supply 350 is the AC power supply, but may be a DC power supply. In this case, the motor vehicle 200 may be, for example, structured such that the charger 212 is omitted.

The embodiment described above is directed to, for example, the structure in which the connector 302 is housed in the housing space at the top of the movable unit 300a. For example, a socket may be exposed on the side of the top of the movable unit 300a. With this structure, the user can charge the battery 214 mounted on the motor vehicle 200 by connecting the inlet 220 of the motor vehicle 200 to the socket of the charging stand 300 with an outlet cable prepared separately. Alternatively, a terminal connectable to an inlet provided at the bottom of the motor vehicle 200 may be provided at the top of the movable unit 300a. With this structure, the inlet of the motor vehicle 200 and the charging stand are electrically connected by setting the movable unit 300a into the second state. Therefore, the user can charge the battery 214 mounted on the motor vehicle 200 without connecting the inlet of the motor vehicle 200 and the charging stand.

In the embodiment described above, the casing of the charging stand 300 has, for example, the cylindrical shape, but only needs to have a shape in which the ascending and descending operations are possible, and the shape is not particularly limited to the cylindrical shape. For example, the casing of the charging stand 300 may have a rectangular parallelepiped shape.

In the embodiment described above, the authentication process is executed by the control device 308 of the charging stand 300, but may be executed by the management server 600. That is, when the charging stand 300 is in the first state and a charging request is received, the control device 308 may transmit specific information to the management server 600, and cause the management server 600 to execute the authentication process. When information indicating that the authentication process is completed is received from the management server 600, the control device 308 may cause the movable unit 300a to ascend.

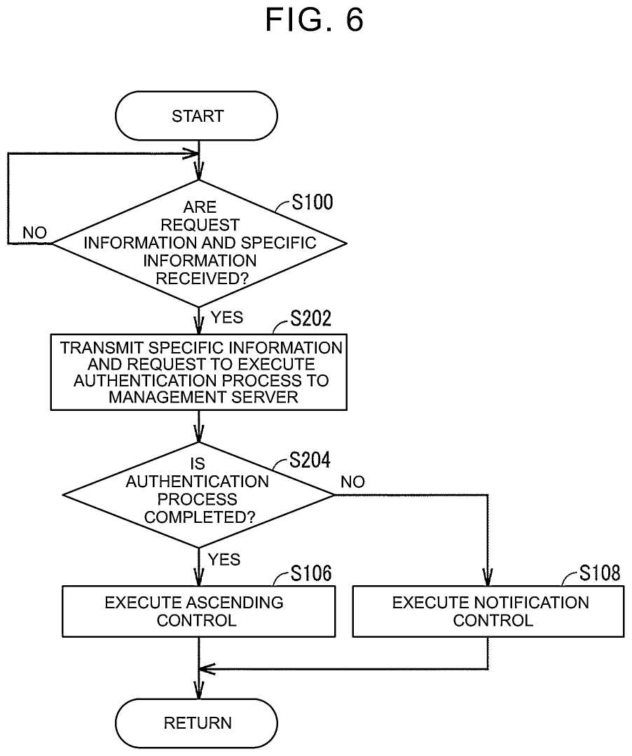

FIG. 6 is a flowchart illustrating an example of processes to be executed by the control device 308 of the charging stand 300 according to a modified example.

The flowchart of FIG. 6 differs from the flowchart of FIG. 5 in that processes of S202 and S204 are executed in place of the processes of S102 and S104. The other processes are similar to the processes illustrated in the flowchart of FIG. 5, and therefore detailed description is not repeated.

When determination is made in S100 that request information and specific information are received (“YES” in S100), the processes proceed to S202.

In S202, the control device 308 transmits, to the management server 600, the specific information and information indicating a request to execute the authentication process. Then, the control device 308 advances the processes to S204. The management server 600 executes the authentication process when the specific information and the information indicating the request to execute the authentication process are received from the charging stand 300. Details of the authentication process are similar to the details of the authentication process executed in the process of S102 of FIG. 5, and therefore detailed description is not repeated. When the authentication process is completed, the management server 600 transmits information indicating the completion to the charging stand 300.

In S204, the control device 308 determines whether the authentication process is completed. The control device 308 determines that the authentication process is completed, for example, when the information indicating that the authentication process is completed is received from the management server 600 before a predetermined period elapses from the timing when the specific information and the information indicating the request to execute the authentication process are transmitted to the management server 600. When determination is made that the authentication process is completed (“YES” in S204), the processes proceed to S106.

The control device 308 determines that the authentication process is not completed, for example, when the information indicating that the authentication process is completed is not received from the management server 600 before the predetermined period elapses. When determination is made that the authentication is not completed (“NO” in S204), the processes proceed to S108.

Also in this case, whether the charging stand is available to the user can be determined without setting the charging stand into the second state. Thus, the spoilage of the convenience of the charging stand can be suppressed.

In the embodiment described above, the ascending control is executed when determination is made that the authentication process is completed. The ascending of the movable unit 300a may be permitted. For example, it is assumed that the ascending and descending device 306 manually causes the movable unit 300a to ascend or descend and the control device 308 can control the state of a switching device configured to switch a locked state in which the ascent or descent of the movable unit 300a by the ascending and descending device 306 is prohibited and an unlocked state in which the prohibition of the ascent or descent is terminated. When determination is made that the authentication process is completed, the control device 308 may permit the ascent of the movable unit 300a, and switch the ascending and descending device 306 from the locked state to the unlocked state. Thus, the user may manually cause the movable unit 300a to ascend or descend.

In the embodiment described above, the control device 308 receives the request information and the specific information from, for example, the mobile terminal 700. For example, the control device 308 may receive the request information and the specific information from the motor vehicle 200.

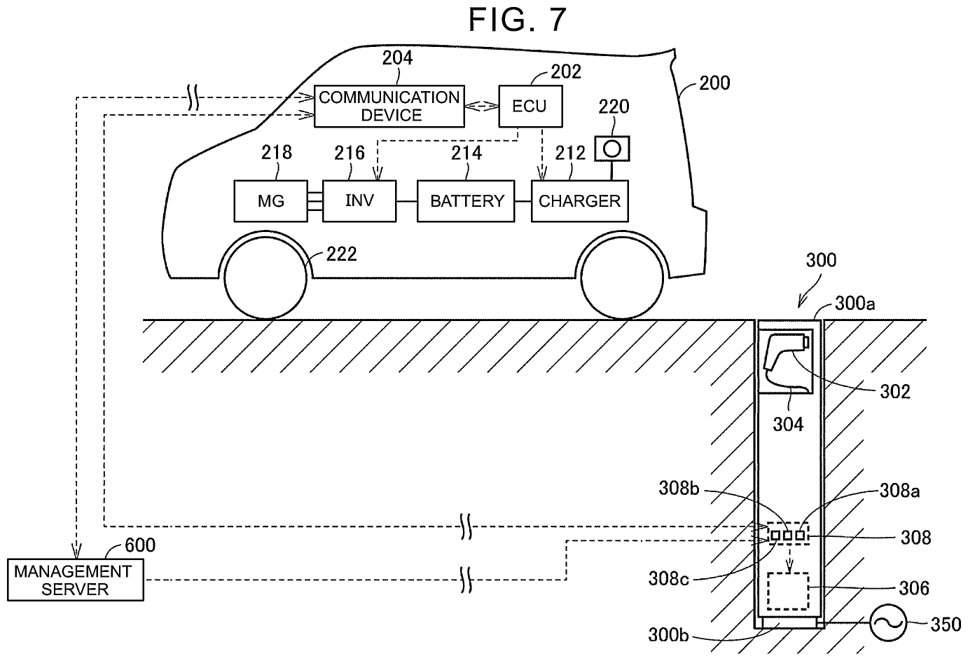

FIG. 7 is a diagram illustrating an example of the structures of a motor vehicle 200 and a charging stand 300 according to a modified example. Regarding the structures of the motor vehicle 200 and the charging stand 300, FIG. 7 differs from FIG. 1 in that the motor vehicle 200 further includes an ECU 202 and a communication device 204. The other structure is similar to the structure of the motor vehicle 200 illustrated in FIG. 1, and therefore detailed description is not repeated.

The communication device 204 can communicate various types of information with devices outside the motor vehicle 200. For example, the communication device 204 is communicable with the management server 600 and with the communicator 308c of the control device 308 of the charging stand 300.

When the motor vehicle 200 comes into a range in which communication can be established with the charging stand 300, the ECU 202 of the motor vehicle 200 automatically executes an operation for establishing the communication with the charging stand 300. Alternatively, when the motor vehicle 200 comes into the range in which communication can be established with the charging stand 300 and an action for establishing the communication with the charging stand 300 is made on a user interface (for example, a touch panel display) of the motor vehicle 200 of the user, the ECU 202 executes the operation for establishing the communication with the charging stand 300.

At this time, the user makes an action for requesting the charging using the charging stand 300 on the user interface of the motor vehicle 200, and the ECU 202 of the motor vehicle 200 transmits request information and specific information to the charging stand 300. For example, the specific information may be identification information related to the motor vehicle 200 or the user. The specific information may be identification information unique to the user, such as a phone number or an ID number assigned to the user at the time of preregistration, identification information set by the user, such as a password registered at the time of preregistration, unique identification information such as a serial number of the motor vehicle 200 that is registered at the time of preregistration, or information obtained by combining a plurality of pieces of the information described above.

Also in this case, whether the charging stand is available to the user can be determined without setting the charging stand into the second state. Thus, the spoilage of the convenience of the charging stand can be suppressed.

The embodiment described above is directed to the example in which the request information and the specific information are transmitted from the mobile terminal 700 to the charging stand 300 and the authentication process is executed in the charging stand 300. The mobile terminal 700 may transmit the request information to the charging stand 300 via the management server 600. For example, the mobile terminal 700 transmits the request information and the specific information to the management server 600. At this time, the request information includes information for determining the charging stand 300. The management server 600 may execute the authentication process, and transmit the request information to the charging stand 300 when the authentication process is completed. Alternatively, the management server 600 may transmit the request information and the specific information to the charging stand 300, and the authentication process may be executed in the charging stand 300.

All or part of the modified examples may be combined as appropriate. It should be understood that the embodiment disclosed herein is illustrative but is not limitative in all respects. The scope of the present disclosure is defined by the claims rather than the above description, and is intended to encompass meanings of equivalents to the elements in the claims and all modifications within the scope of the claims.

What is claimed is:

1. A charging apparatus installed at a bottom of a hollow in a ground and configured to charge a power storage device mounted on a vehicle, the charging apparatus comprising:
a movable unit including a connection device configured to connect to the power storage device;
an ascending and descending device configured to cause the movable unit to ascend or descend between a first state and a second state, the first state being a state in which the movable unit is housed under the ground, the second state being a state in which the movable unit is exposed above the ground and the power storage device and the connection device are connectable together;
a communication device configured to communicate with a device outside the charging apparatus; and
a control device configured to
control the ascending and descending device by using information received via the communication device, and
permit ascent of the movable unit when following conditions (i) to (iii) are satisfied:
(i) the charging apparatus is in the first state;
(ii) request information indicating a request to charge a charging target vehicle is received via the communication device; and
(iii) determination is made that an authentication process for permitting charging of the charging target vehicle is completed.

2. The charging apparatus according to claim 1, wherein the control device is configured to execute the authentication process when the request information is received.

3. The charging apparatus according to claim 1, wherein:
the device outside the charging apparatus includes a server and a device configured to transmit the request information; and
the authentication process is executed by the server.

4. The charging apparatus according to claim 2, wherein:
the device configured to transmit the request information includes at least one of a mobile terminal and the vehicle; and
the control device is configured to, when the request information is received, acquire information necessary for the authentication process from the device configured to transmit the request information.
